(19) United States
(12) Patent Application Publication
(10) Pub. No.: US 2014/0112342 A1
(43) Pub. Date: Apr. 24, 2014

(54) Cascaded Communication of Serialized Data Streams Through Devices and Their Resulting Operation

(71) Applicants: John W. Marshall, Cary, NC (US); Steven Philip Holmes, Wake Forest, NC (US); Jeffrey Nelson Shaw, Stow, MA (US); Michael E. Lipman, Harvard, MA (US); Matthew Harper, Salem, NH (US); Mohammed Ismael Tatar, Kanata (CA); James A. Markevitch, Palo Alto, CA (US)

(72) Inventors: John W. Marshall, Cary, NC (US); Steven Philip Holmes, Wake Forest, NC (US); Jeffrey Nelson Shaw, Stow, MA (US); Michael E. Lipman, Harvard, MA (US); Matthew Harper, Salem, NH (US); Mohammed Ismael Tatar, Kanata (CA); James A. Markevitch, Palo Alto, CA (US)

(21) Appl. No.: 13/658,960

(22) Filed: Oct. 24, 2012

(51) Int. Cl. H04L 12/56

(52) U.S. Cl. 370/392

(57) ABSTRACT

In one embodiment, an apparatus cascades groups of serialized data streams through devices, and performs operations based on information communicated therein. A received group of serialized data streams is aligned, but not framed, and forwarded to a next device (e.g., a next stage in a linear or tree cascaded formation of devices). Eliminating the framing and subsequent serialization operations performed on the received group of serialized data streams reduces the latency of communications through the cascaded devices, which can be significant when considered in relation to the high-speed communication rates. The received group of serialized data streams is also framed to create a sequence of data frames for processing (e.g., associative memory lookup operations, controlling multiplexing of received downstream serialized data streams, general or other processing) within the device.

### TECHNICAL FIELD

The present disclosure relates generally to communicating serialized data streams among devices, and their operation according to information communicated therein.

### BACKGROUND

The communications industry is rapidly changing to adjust to emerging technologies and ever increasing customer demand. This customer demand for new applications and increased performance of existing applications is driving communications network and system providers to employ networks and systems having greater speed and capacity. In trying to achieve these goals, a common approach taken by many communications providers is to use packet switching technology.

The communication rates between devices affects the rate at which devices can operate in response to communicated information. As such, faster intercommunications techniques are continuously being developed and deployed. Interlaken is one example of a protocol that uses bundles of serial links to create a logical connection between two devices. Framed data is serialized and sent across the bundles of links. A receiving device reframes the serialized data to recover the original sequence of data frames.

### BRIEF DESCRIPTION OF THE DRAWINGS

The appended claims set forth the features of one or more embodiments with particularity. The embodiment(s), together with its advantages, may be best understood from the following detailed description taken in conjunction with the accompanying drawings of which:

FIG. 1A illustrates a device operating according to one embodiment;

FIG. 1B illustrates a process according to one embodiment;

FIG. 2A illustrates a device operating according to one embodiment;

FIG. 2B illustrates a device operating according to one embodiment;

FIG. 2C illustrates a process according to one embodiment; and

FIG. 3 illustrates a device operating according to one embodiment.

### DESCRIPTION OF EXAMPLE EMBODIMENTS

### 1. Overview

Disclosed are, inter alia, methods, apparatus, computer-storage media, mechanisms, and means associated with cascaded communication of groups of serialized data streams through devices, and the operations of these devices based on information communicated therein.

One embodiment includes an apparatus, comprising a first integrated circuit device, which includes a first interface configured to receive a first plurality of serialized data streams from a source external to the first integrated circuit device; first framing circuitry, communicatively coupled to the first interface, configured to produce a first sequence of data frames from the first plurality of serialized data streams; processing circuitry configured to perform operations based on the first sequence of data frames; first phase aligning circuitry, communicatively coupled to the first interface, configured to align, but not frame, the first plurality of serialized data streams to produce a first aligned plurality of serialized data streams; and a second interface configured to produce the first aligned plurality of serialized data streams from the first integrated circuit device, with the first aligned plurality of serialized data streams not being framed within the first integrated circuit device. In one embodiment, said processing circuitry includes associative memory circuitry (e.g., content-addressable memory circuitry, ternary content-addressable memory circuitry). In one embodiment, said processing circuitry includes multiplexing circuitry.

One embodiment includes an integrated circuit device, comprising: an input interface configured to receive an input plurality of serialized data streams from a source external to the integrated circuit device; first phase aligning circuitry, communicatively coupled to the input interface, configured to align, but not frame, the input plurality of serialized data streams to produce a first aligned plurality of serialized data streams; a first interface configured to produce the first aligned plurality of serialized data streams from the integrated circuit device, with the first aligned plurality of serialized data streams not being framed within the integrated circuit device; second phase aligning circuitry, communicatively coupled to the input interface, configured to align, but not frame, the input plurality of serialized data streams to produce a second aligned plurality of serialized data streams; a second interface configured to produce the second aligned plurality of serialized data streams from the integrated circuit device, with the second aligned plurality of serialized data streams not being framed within the integrated circuit device; a third interface configured to receive a second plurality of serialized data streams from a source external to the integrated circuit device; first framing circuitry, communicatively coupled to the third interface, configured to produce a first sequence of data frames from the second plurality of serialized data streams; a fourth interface configured to receive a third plurality of serialized data streams from a source external to the integrated circuit device; second framing circuitry, communicatively coupled to the fourth interface, configured to produce a second sequence of data frames from the third plurality of serialized data streams; combining and framing circuitry configured to produce an output plurality of serialized data streams based on the first sequence of data frames and on the second sequence of data frames; and an output configured to produce the output plurality of serialized data streams from the integrated circuit device.

One embodiment comprises: receiving, by a device, a first plurality of serialized data streams from a source external to the first device; communicating, from the device, one or more copies of the first plurality of serialized data streams, each of said one or more copies of the first plurality of serialized data streams having been phase aligned by the device, but not framed by the device; framing each of one or more second plurality of serialized data streams received from a same or different source external to the first device to generate one or more sequences of data frames; producing a result based on said one or more sequences of data frames; generating an output plurality of serialized data streams including by framing the result; and sending, from the device, the output plurality of serialized data streams. In one embodiment, said producing the result includes: framing the first plurality of serialized data streams to generate an input sequence of data frames; processing, by the device, according to instructions or data received in the input sequences of data frames, to produce an intermediate result; and processing the intermediate result and information received in said one or more sequences of data frames resulting in the result.

### 2. Description

Disclosed are, inter alia, methods, apparatus, computer-storage media, mechanisms, and means associated with cascaded communication of groups of serialized data streams through devices, and the operations of these devices based on information communicated therein. Typically, a received group of serialized data streams is aligned, but not framed, and forwarded to a next device (e.g., a next stage in a linear or tree cascaded formation of devices). Eliminating the framing and subsequent serialization operations performed on the received group of serialized data streams reduces the latency of communications through the cascaded devices, which can be significant when considered in relation to the high-speed communication rates. The received group of serialized data streams is also framed to create a sequence of data frames for processing within the device.

Embodiments described herein include various elements and limitations, with no one element or limitation contemplated as being a critical element or limitation. Each of the claims individually recites an aspect of the embodiment in its entirety. Moreover, some embodiments described may include, but are not limited to, inter alia, systems, networks, integrated circuit chips, embedded processors, ASICs, methods, and computer-readable media containing instructions. One or multiple systems, devices, components, etc. may comprise one or more embodiments, which may include some elements or limitations of a claim being performed by the same or different systems, devices, components, etc. A processing element may be a general processor, task-specific processor, a core of one or more processors, or other co-located, resource-sharing implementation for performing the corresponding processing. The embodiments described hereinafter embody various aspects and configurations, with the figures illustrating exemplary and non-limiting configurations. Note, computer-readable media and means for performing methods and processing block operations (e.g., a processor and memory or other apparatus configured to perform such operations) are disclosed and are in keeping with the extensible scope and spirit of the embodiments. Note, the term “apparatus” is used consistently herein with its common definition of an appliance or device.

Note, the steps, connections, and processing of signals and information illustrated in the figures, including, but not limited to, any block and flow diagrams and message sequence charts, may typically be performed in the same or in a different serial or parallel ordering and/or by different components and/or processes, threads, etc., and/or over different connections and be combined with other functions in other embodiments, unless this disables the embodiment or a sequence is explicitly or implicitly required (e.g., for a sequence of read the value, process said read value—the value must be obtained prior to processing it, although some of the associated processing may be performed prior to, concurrently with, and/or after the read operation). Also note, nothing described or referenced in this document is admitted as prior art to this application unless explicitly so stated.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the terms “first,” “second,” etc. are typically used herein to denote different units (e.g., a first element, a second element). The use of these terms herein does not necessarily connote an ordering such as one unit or event occurring or coming before another, but rather provides a mechanism to distinguish between particular units. Moreover, the phrases “based on x” and “in response to x” are used to indicate a minimum set of items “x” from which something is derived or caused, wherein “x” is extensible and does not necessarily describe a complete list of items on which the operation is performed, etc. Additionally, the phrase “coupled to” is used to indicate some level of direct or indirect connection between two elements or devices, with the coupling device or devices modifying or not modifying the coupled signal or communicated information. Moreover, the term “or” is used herein to identify a selection of one or more, including all, of the conjunctive items. Additionally, the transitional term “comprising,” which is synonymous with “including,” “containing,” or “characterized by,” is inclusive or open-ended and does not exclude additional, unrecited elements or method steps. Finally, the term “particular machine,” when recited in a method claim for performing steps, refers to a particular machine within the 35 USC §101 machine statutory class.

One embodiment includes an apparatus, comprising a first integrated circuit device, which includes a first interface configured to receive a first plurality of serialized data streams from a source external to the first integrated circuit device; first framing circuitry, communicatively coupled to the first interface, configured to produce a first sequence of data frames from the first plurality of serialized data streams; processing circuitry configured to perform operations based on the first sequence of data frames; first phase aligning circuitry, communicatively coupled to the first interface, configured to align, but not frame, the first plurality of serialized data streams to produce a first aligned plurality of serialized data streams; and a second interface configured to produce the first aligned plurality of serialized data streams from the first integrated circuit device, with the first aligned plurality of serialized data streams not being framed within the first integrated circuit device.

In one embodiment, said processing circuitry is configured to generate a second sequence of data frames; and wherein the first integrated circuit device includes: second framing circuitry configured to produce a second plurality of serialized data streams based on the second sequence of data frames; and a third interface configured to produce the second plurality of serialized data streams from the first integrated circuit device. In one embodiment, said processing circuitry includes associative memory circuitry configured to perform a lookup operation, based on a lookup word generated from, or included in, the first sequence of data frames, to produce a first lookup result; wherein said processing circuitry is configured to include the first lookup result in the second sequence of data frames.

In one embodiment, the first integrated circuit device includes: a fourth interface configured to receive a third plurality of serialized data streams from a source external to the first integrated circuit device; and third framing circuitry, communicatively coupled to the fourth interface, configured to produce a third sequence of data frames from the third plurality of serialized data streams; and wherein said processing circuitry is configured to perform operations based on the first sequence of data frames and on the third sequence of data frames.

In one embodiment, said processing circuitry includes associative memory circuitry configured to perform a lookup operation, based on a lookup word generated from, or included in, the first sequence of data frames, to produce a first lookup result; wherein the third sequence of data frames includes a second lookup result corresponding to an associative memory lookup operation performed in response to an instruction included in the first aligned plurality of serialized data streams; and wherein said processing circuitry is configured to determine an integrated circuit device lookup result based on the first lookup result and the second lookup result, and to include the integrated lookup result in the second sequence of data frames. In one embodiment, the apparatus includes a second integrated circuit device communicatively coupled to receive the first aligned plurality of serialized data streams and to generate the third plurality of serialized data streams; and wherein the second integrated circuit device includes associative memory circuitry configured to perform a lookup operation, based on a lookup word generated from, or included in, the first aligned plurality of serialized data streams, to produce the second lookup result.

In one embodiment, the apparatus includes a second integrated circuit device communicatively coupled to receive the first aligned plurality of serialized data streams and to generate the third plurality of serialized data streams; wherein the second integrated circuit device includes associative memory circuitry configured to perform a lookup operation, based on a lookup word generated from, or included in, the first aligned plurality of serialized data streams, to produce a second lookup result included in the third plurality of serialized data streams; wherein said processing circuitry includes associative memory circuitry configured to perform a lookup operation, based on a lookup word generated from, or included in, the first sequence of data frames, to produce a first lookup result; wherein said associative memory circuitry of the first integrated circuit device has a higher priority than said associative memory circuitry of the second integrated circuit device; and wherein said processing circuitry is configured to determine an integrated circuit device lookup result based on the first lookup result and said higher priority of said associative memory circuitry of the first integrated circuit device prior to receiving the second lookup result, and to include the integrated lookup result in the second sequence of data frames.

In one embodiment, the apparatus includes a second integrated circuit device communicatively coupled to receive the first aligned plurality of serialized data streams and to generate the third plurality of serialized data streams; and wherein the second integrated circuit device includes general processing circuitry, without associative memory circuitry, configured to perform operations based on one or more instructions generated from, or included in, the first aligned plurality of serialized data streams, and to produce one or more results included in the third plurality of serialized data streams. In one embodiment, the first integrated circuit device is configured to include said one or more results in the second sequence of data frames and the second plurality of serialized data streams.

In one embodiment, said perform operations based on the first sequence of data frames and on the third sequence of data frames includes processing according to one or more instructions in the third sequence of data frames which were received in the third plurality of serialized data streams. In one embodiment, the first integrated circuit device includes: second phase aligning circuitry, communicatively coupled to the first interface, configured to align, but not frame, the first plurality of serialized data streams to produce a second aligned plurality of serialized data streams; a fifth interface configured to produce the second aligned plurality of serialized data streams from the first integrated circuit device, with the second aligned plurality of serialized data streams not being framed within the first integrated circuit device; a sixth interface configured to receive a fourth plurality of serialized data streams from a source external to the first integrated circuit device; and fourth framing circuitry, communicatively coupled to the sixth interface, configured to produce a fourth sequence of data frames from the fourth plurality of serialized data streams; and wherein said processing circuitry is configured to perform operations based on the first sequence of data frames, based on the third sequence of data frames, and based on the fourth sequence of data frames.

In one embodiment, the first integrated circuit device includes: second phase aligning circuitry, communicatively coupled to the first interface, configured to align, but not frame, the first plurality of serialized data streams to produce a second aligned plurality of serialized data streams; and a fifth interface configured to produce the second aligned plurality of serialized data streams from the first integrated circuit device, with the second aligned plurality of serialized data streams not being framed within the first integrated circuit device.

One embodiment includes an integrated circuit device, comprising: an input interface configured to receive an input plurality of serialized data streams from a source external to the integrated circuit device; first phase aligning circuitry, communicatively coupled to the input interface, configured to align, but not frame, the input plurality of serialized data streams to produce a first aligned plurality of serialized data streams; a first interface configured to produce the first aligned plurality of serialized data streams from the integrated circuit device, with the first aligned plurality of serialized data streams not being framed within the integrated circuit device; second phase aligning circuitry, communicatively coupled to the input interface, configured to align, but not frame, the input plurality of serialized data streams to produce a second aligned plurality of serialized data streams; a second interface configured to produce the second aligned plurality of serialized data streams from the integrated circuit device, with the second aligned plurality of serialized data streams not being framed within the integrated circuit device; a third interface configured to receive a second plurality of serialized data streams from a source external to the integrated circuit device; first framing circuitry, communicatively coupled to the third interface, configured to produce a first sequence of data frames from the second plurality of serialized data streams; a fourth interface configured to receive a third plurality of serialized data streams from a source external to the integrated circuit device; second framing circuitry, communicatively coupled to the fourth interface, configured to produce a second sequence of data frames from the third plurality of serialized data streams; combining and framing circuitry configured to produce an output plurality of serialized data streams based on the first sequence of data frames and on the second sequence of data frames; and an output configured to produce the output plurality of serialized data streams from the integrated circuit device.

One embodiment comprises: receiving, by a device, a first plurality of serialized data streams from a source external to the first device; communicating, from the device, one or more copies of the first plurality of serialized data streams, each of said one or more copies of the first plurality of serialized data streams having been phase aligned by the device, but not framed by the device; framing each of one or more second plurality of serialized data streams received from a same or different source external to the first device to generate one or more sequences of data frames; producing a result based on said one or more sequences of data frames; generating an output plurality of serialized data streams including by framing the result; and sending, from the device, the output plurality of serialized data streams.

In one embodiment, the device is an integrated circuit device in a cascade of a plurality of integrated circuit devices. In one embodiment, said producing the result includes multiplexing said one or more sequences of data frames. In one embodiment, said producing the result includes: framing the first plurality of serialized data streams to generate an input sequence of data frames; processing, by the device, according to instructions or data received in the input sequences of data frames, to produce an intermediate result; and processing the intermediate result and information received in said one or more sequences of data frames resulting in the result. In one embodiment, said processing according to said instructions or data received in the input sequences of data frames to produce the intermediate result includes performing an associative memory lookup operation in the device based on a lookup word generated from, or included in, the input sequences of data frames. In one embodiment, said information received in said one or more sequences of data frames includes a subsequent stage lookup result performed according to instructions or data included in at least one of said one or more copies of said serialized data streams said communicated from the device. In one embodiment, said one or more copies of the first plurality of serialized data streams consists of one copy of the first plurality of serialized data streams; and wherein said one or more second plurality of serialized data streams consists of one plurality of serialized data streams.

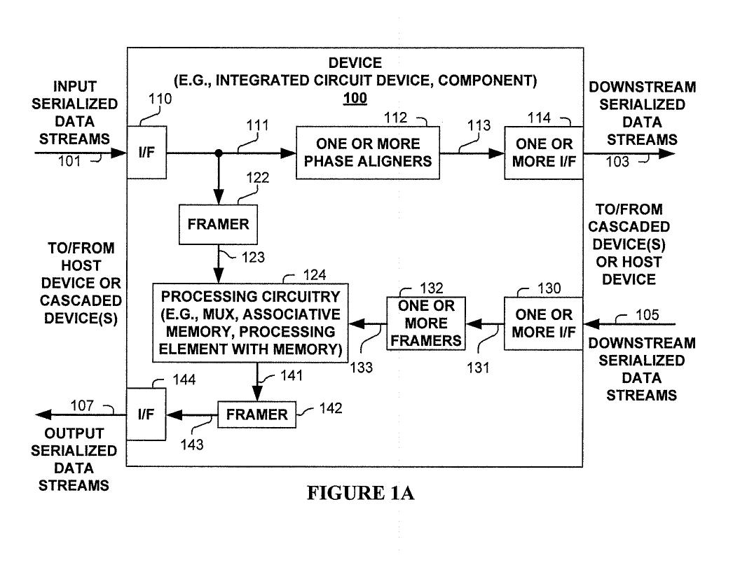

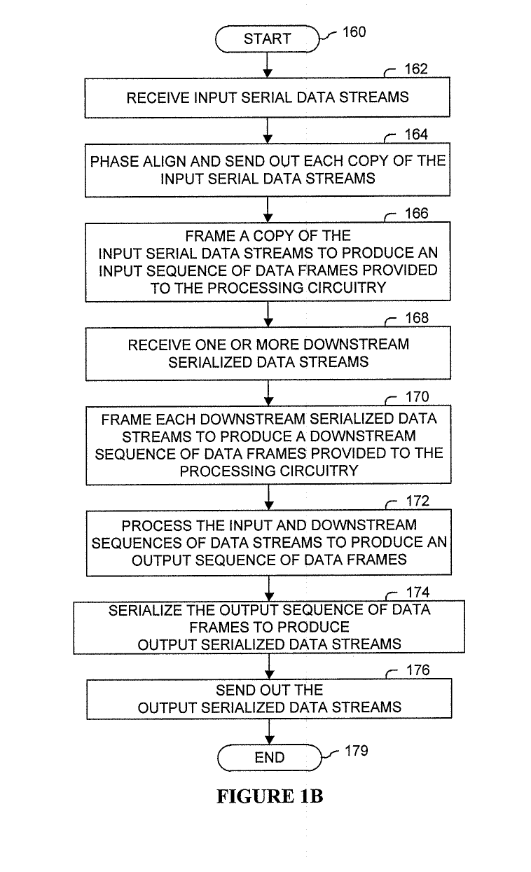

Expressly turning to the figures, FIG. 1A illustrates a device 100 (e.g., an integrated circuit device, component), which is in communication with other device(s) in a cascaded arrangement. In one embodiment, input serialized data streams 101 are received from, and output serialized data streams 107 are communicated to, a host device or other device in the cascaded arrangement. In one embodiment, downstream serialized data streams 103 are communicated to, and downstream serialized data streams 105 are received from, a host device or other device in the cascaded arrangement. In one embodiment, multiple copies of device 100 are accordingly communicatively coupled in a cascaded arrangement (e.g., downstream serialized data streams 103 of a first device corresponds to input serialized data streams 101 of a second device, and output serialized data streams 107 of the second device corresponds to downstream serialized data streams 105 of the first device). In one embodiment, an apparatus includes one or more copies of device 100 and one or more different devices.

In a manner such as that illustrated by FIG. 1A, input serialized data streams can be proliferated quickly and efficiently through an apparatus comprising multiple devices 100, or variants thereof, without framing and serialization delays at each cascaded device 100 of an apparatus. As shown, input serialized data streams 101 are received on interface 110 of device 100 as serialized data streams 111. For each of one or more downstream serialized data streams 103 to be send from device 100 via an interface 114, a phase aligner 112 phase aligns a copy of serialized data streams 111, with this aligned serialized data streams 113 provided to an output interface 114. Note, downstream serialized data streams 103 is a phase aligned, with no framing, copy of input serialized data streams 101. In one embodiment, information included in serialized data steams 101, 103, 105, and/or 107 is channelized such that it can be addressed to a single device, multiple devices, or all devices so they can be provided same or different information (e.g., instructions, parameters, data) for performing operations.

Additionally, framer 122 frames a copy of serialized data streams 111 to produce a sequence of data frames 123 for internal processing. In particular, data frames 123 are received by processing circuitry 124. In one embodiment, data frames 123 include instructions, parameters, lookup words, and/or other information for use by processing circuitry 124. For example, such information may include an instruction and/or parameters to perform a lookup operation based on a particular lookup word in associative memory circuitry within processing circuitry 124. In one embodiment, such information may include an instruction and/or parameters to perform some processing (e.g., packet processing, regular expression matching, any data manipulation, multiplexing of sequences of data frames).

Further, processing circuitry 124 may also operate, alone or in conjunction with sequence of data frames 123, according to data and/or instructions in information received in one or more groups of downstream serialized data streams 105 received on interface(s) 130. Each of these one or more serialized data streams 131 are processed by a framer 132 to produce a sequence of data frames 133 provided to processing circuitry 124.

Processing circuitry 124 performs its operations independently, or also on data received from another cascaded device, and produces an output sequence of data frames 141, which are processed by framer 142 to generate serialized data streams 143, which are sent from interface 144 as output serialized data streams 107.

In one embodiment, devices 100 operate asynchronously in that they do not need to wait for a result from a neighboring device to proceed, and may perform multiple operations independently of the other devices 100 in the apparatus. Further, typically in a cascade of devices there is one host device such as that communicatively coupled to a device 100 by input serialized data streams 101 and output serialized data streams 107. However, in one embodiment, the same host device or another host device is communicatively coupled to a last stage of cascaded devices 100 through downstream serialized data streams 103 and 105.

FIG. 1B illustrates a process performed in one embodiment of a device (e.g., device 100 of FIG. 1A). Processing begins with process block 160. In process block 162, input serial data streams are received. In process block 164, one or more copies of the received input serial data streams are phase aligned and sent out (unless, in one embodiment, it is a last stage with no subsequent device to receive this information). In process block 166, a copy of the received input serialized data streams is framed to produce an input sequence to data frames, which are provided to processing circuitry.

In process block 168, one or more downstream serialized data streams are received from other connected devices. In process block 170, each of these received downstream serialized data streams is framed to produce a downstream sequence of data frames provided to processing circuitry.

In process block 172, processing circuitry processes the input and downstream sequences of data streams to produce an output sequence of data frames. In process block 174, the output sequence of data frames is serialized to produce output serialized data streams, which are sent out of the device in process block 176. Processing of the flow diagram of FIG. 1B is complete as indicated by process block 179.

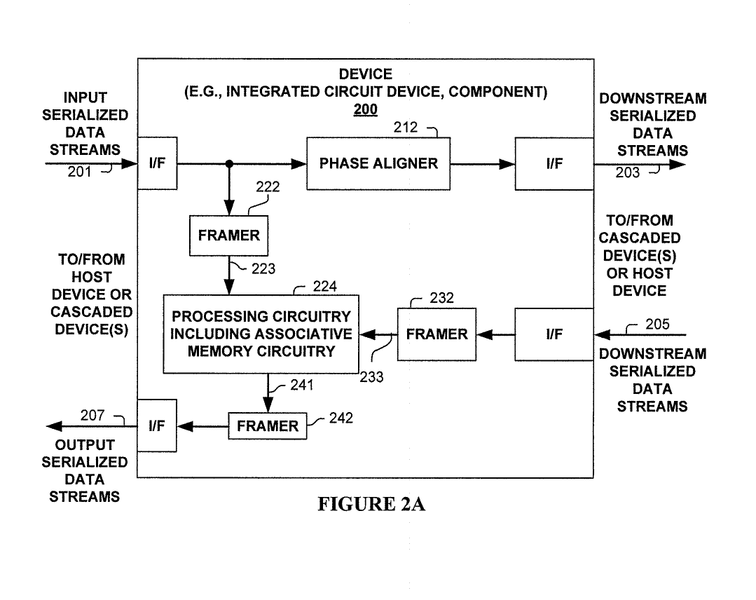

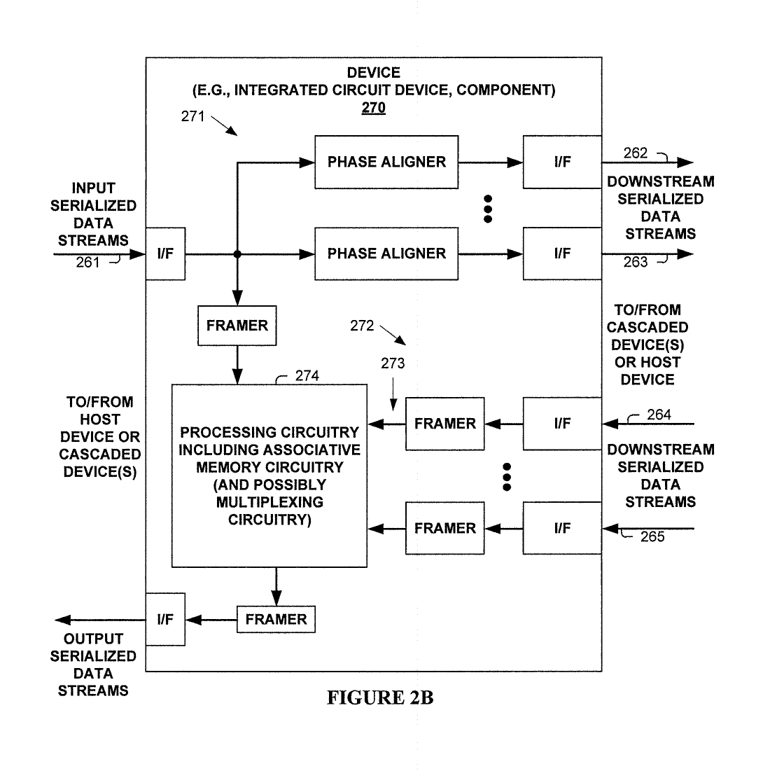

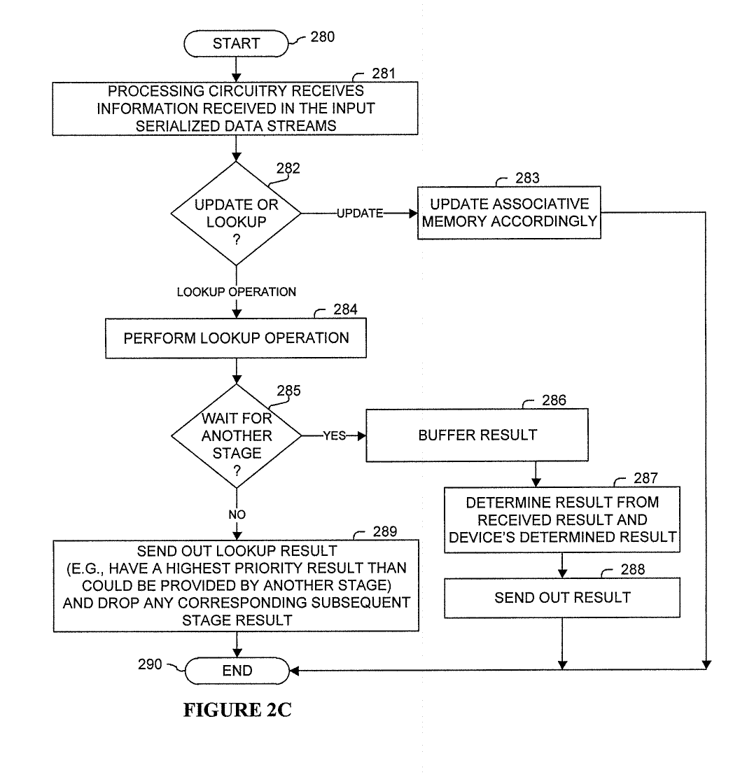

FIG. 2A illustrates device 200 of one embodiment (e.g., of device 100 of FIG. 1A) in which processing circuitry 224 includes associative memory circuitry. As shown, input serialized data streams 201 are received by device 200, which phase aligns (by phase aligner 212) the received serialized data streams and sends them out as downstream serialized data streams 203 if there is a downstream connected device or host. A copy of input serialized data streams 201 is also framed (by framer 222) to produce sequence of data frames 223. Additionally, downstream serialized data streams 205 are received and framed (by framer 232) to produce a second sequence of data frames 233.

Processing circuitry receives and processes sequences of data frames 223 and 233, including typically performing one or more lookup operations in its associative memory circuitry. Processing circuitry 224 determines one or more results included in sequence of data frames 241, which are serialized (by framer 242) to generate output serialized data streams 207 sent from device 200 to another device (e.g., another device 200, device 100 of FIG. 1A, host device).

For example, in one embodiment, each device 200 of a cascade of multiple devices 200 includes associative memory circuitry configured to perform lookup operations. Each of these devices 200 may be instructed to perform a lookup operation in its associative memory circuitry, which can be done in parallel as the instruction information is quickly proliferated to all cascaded devices 200 in the phase aligned, but not reframed, input serialized data streams 201/downstream serialized data streams 203. In this configuration, typically the highest priority associative memory entries are included in the first device 200 (e.g., the first associative memory device receiving instructions from a host device and sending instructions to other associative memory device(s) 200 in the cascade of devices), with priority decreasing in the sequence of devices 200 in the cascade of devices.

In one embodiment, devices 200 operate asynchronously in that they do not need to wait for a result from a neighboring device to proceed, and may perform multiple operations independently of the other devices 200 in the apparatus. Also, by structuring the priority of associative memory entries of devices 200 from highest to lowest, a device 200 in which its associative memory circuitry (224) identifies a match/hit, it can send out the result without waiting for a result in downstream serialized data streams 205 sent from its neighbor (which typically are subsequently dropped).

FIG. 2B illustrates device 270, which is one embodiment of device 100 of FIG. 1A. Device 270 operates in a manner similar to device 200 of FIG. 2A with the explicit capability for communicatively coupling to multiple downstream devices in parallel. Input serialized data streams 261 are cascaded to each of these downstream devices after each copy has its phase aligned. Circuitry 271 is configured to communicate input serialized data streams 261, aligned by device 270, to each of n devices as downstream serialized data streams 262-263 (e.g., one to each of n devices). Circuitry 272 is configured to receive and frame each of downstream serialized data streams 264-265 (e.g., one from each of n devices) to provide n sequences of data frames 273 for processing by processing circuitry 274. In one embodiment, processing circuitry 274 includes multiplexing circuitry in addition to the associative memory circuitry.

FIG. 2C illustrates a process performed by processing circuitry 224 of FIG. 2A and/or processing circuitry 274 of FIG. 2B in one embodiment. Processing begins with process block 280. In process block 281, processing circuitry acquires the information from the input serialized data streams (and/or possibly in downstream serialized data streams) received by the device including processing circuitry. As determined in process block 282, if the information corresponds to an instruction to update the associative memory (e.g., program associative memory entries, profiles), then in process block 283, the associative memory programming is updated accordingly. Processing of the flow diagram of FIG. 2C is complete as indicated by process block 290.

Otherwise, as determined in process block 282, the information corresponds to a lookup operation, which is performed in process block 284. As determined in process block 285, if the device does not need to wait from other result(s) from another device, then in process block 289, the lookup result is sent out. For example, if the processing circuitry determines a match/hit and all downstream devices have a lower priority or there are no downstream devices, then the result can be sent out immediately. If, however, the device needs to wait for other results as determined in process block 285, then the result determined by the processing circuitry is buffered and the processing circuitry operates on other tasks. In process block 287, in response to receiving the other result(s), an output result is determined from all of the intermediate results (e.g., local and remotely determined). In process block 288, the lookup result is sent out. Processing of the flow diagram of FIG. 2C is complete as indicated by process block 290.

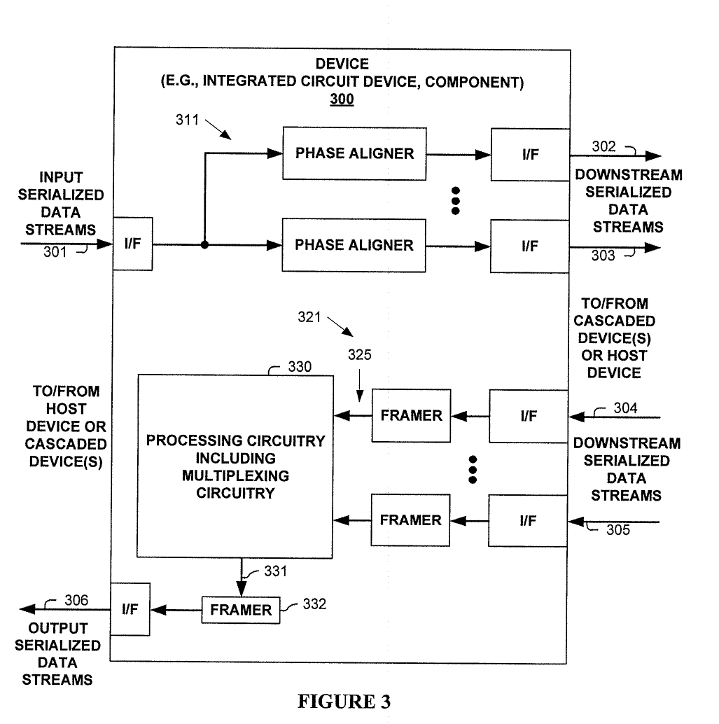

FIG. 3 illustrates device 300, which is one embodiment of device 100 of FIG. 1A. Similarly described in relation to FIG. 2B, device 300 includes the explicit capability for communicatively coupling to multiple downstream devices in parallel. Input serialized data streams 301 are cascaded to each of these downstream devices after each copy has its phase aligned. Circuitry 311 is configured to communicate input serialized data streams 301, aligned by device 300, to each of n devices as downstream serialized data streams 302-303 (e.g., one to each of n devices). Circuitry 321 is configured to receive and frame each of downstream serialized data streams 304-305 (e.g., one from each of n devices) to provide n sequences of data frames 325 for processing by processing circuitry 330. Processing circuitry 330 includes multiplexing circuitry for multiplexing each of the n sequences of data frames 325 to produce a single output sequence of data frames 331, which is serialized by framer 332, resulting in output serialized data streams 306.

In view of the many possible embodiments to which the principles of the disclosure may be applied, it will be appreciated that the embodiments and aspects thereof described herein with respect to the drawings/figures are only illustrative and should not be taken as limiting the scope of the disclosure. For example, and as would be apparent to one skilled in the art, many of the process block operations can be re-ordered to be performed before, after, or substantially concurrent with other operations. Also, many different forms of data structures could be used in various embodiments. The disclosure as described herein contemplates all such embodiments as may come within the scope of the following claims and equivalents thereof.

What is claimed is:

1. An apparatus, comprising:
a first integrated circuit device, including:
a first interface configured to receive a first plurality of serialized data streams from a source external to the first integrated circuit device;
first framing circuitry, communicatively coupled to the first interface, configured to produce a first sequence of data frames from the first plurality of serialized data streams;
processing circuitry configured to perform operations based on the first sequence of data frames;
first phase aligning circuitry, communicatively coupled to the first interface, configured to align, but not frame, the first plurality of serialized data streams to produce a first aligned plurality of serialized data streams; and
a second interface configured to produce the first aligned plurality of serialized data streams from the first integrated circuit device, with the first aligned plurality of serialized data streams not being framed within the first integrated circuit device.

2. The apparatus of claim 1, wherein said processing circuitry is configured to generate a second sequence of data frames; and
wherein the first integrated circuit device includes:
second framing circuitry configured to produce a second plurality of serialized data streams based on the second sequence of data frames; and
a third interface configured to produce the second plurality of serialized data streams from the first integrated circuit device.

3. The apparatus of claim 2, wherein said processing circuitry includes associative memory circuitry configured to perform a lookup operation, based on a lookup word generated from, or included in, the first sequence of data frames, to produce a first lookup result;
wherein said processing circuitry is configured to include the first lookup result in the second sequence of data frames.

4. The apparatus of claim 2, wherein the first integrated circuit device includes:
a fourth interface configured to receive a third plurality of serialized data streams from a source external to the first integrated circuit device; and
third framing circuitry, communicatively coupled to the fourth interface, configured to produce a third sequence of data frames from the third plurality of serialized data streams;
wherein said processing circuitry is configured to perform operations based on the first sequence of data frames and on the third sequence of data frames.

5. The apparatus of claim 4, wherein said processing circuitry includes associative memory circuitry configured to perform a lookup operation, based on a lookup word generated from, or included in, the first sequence of data frames, to produce a first lookup result;
wherein the third sequence of data frames includes a second lookup result corresponding to an associative memory lookup operation performed in response to an instruction included in the first aligned plurality of serialized data streams; and
wherein said processing circuitry is configured to determine an integrated circuit device lookup result based on the first lookup result and the second lookup result, and to include the integrated lookup result in the second sequence of data frames.

6. The apparatus of claim 5, including a second integrated circuit device communicatively coupled to receive the first aligned plurality of serialized data streams and to generate the third plurality of serialized data streams;
wherein the second integrated circuit device includes associative memory circuitry configured to perform a lookup operation, based on a lookup word generated from, or included in, the first aligned plurality of serialized data streams, to produce the second lookup result.

7. The apparatus of claim 4, including a second integrated circuit device communicatively coupled to receive the first aligned plurality of serialized data streams and to generate the third plurality of serialized data streams; and
wherein the second integrated circuit device includes associative memory circuitry configured to perform a lookup operation, based on a lookup word generated from, or included in, the first aligned plurality of serialized data streams, to produce a second lookup result included in the third plurality of serialized data streams;
wherein said processing circuitry includes associative memory circuitry configured to perform a lookup operation, based on a lookup word generated from, or included in, the first sequence of data frames, to produce a first lookup result;
wherein said associative memory circuitry of the first integrated circuit device has a higher priority than said associative memory circuitry of the second integrated circuit device; and
wherein said processing circuitry is configured to determine an integrated circuit device lookup result based on the first lookup result and said higher priority of said associative memory circuitry of the first integrated circuit device prior to receiving the second lookup result, and to include the integrated lookup result in the second sequence of data frames.

8. The apparatus of claim 4, including a second integrated circuit device communicatively coupled to receive the first aligned plurality of serialized data streams and to generate the third plurality of serialized data streams;
wherein the second integrated circuit device includes general processing circuitry, without associative memory circuitry, configured to perform operations based on one or more instructions generated from, or included in, the first aligned plurality of serialized data streams, and to produce one or more results included in the third plurality of serialized data streams.

9. The apparatus of claim 8, wherein the first integrated circuit device is configured to include said one or more results in the second sequence of data frames and the second plurality of serialized data streams.

10. The apparatus of claim 4, wherein said perform operations based on the first sequence of data frames and on the third sequence of data frames includes processing according to one or more instructions in the third sequence of data frames which were received in the third plurality of serialized data streams.

11. The apparatus of claim 4, wherein the first integrated circuit device includes:
second phase aligning circuitry, communicatively coupled to the first interface, configured to align, but not frame, the first plurality of serialized data streams to produce a second aligned plurality of serialized data streams;
a fifth interface configured to produce the second aligned plurality of serialized data streams from the first integrated circuit device, with the second aligned plurality of serialized data streams not being framed within the first integrated circuit device;
a sixth interface configured to receive a fourth plurality of serialized data streams from a source external to the first integrated circuit device; and
fourth framing circuitry, communicatively coupled to the sixth interface, configured to produce a fourth sequence of data frames from the fourth plurality of serialized data streams; and
wherein said processing circuitry is configured to perform operations based on the first sequence of data frames, based on the third sequence of data frames, and based on the fourth sequence of data frames.

12. The apparatus of claim 1, wherein the first integrated circuit device includes:
second phase aligning circuitry, communicatively coupled to the first interface, configured to align, but not frame, the first plurality of serialized data streams to produce a second aligned plurality of serialized data streams; and
a fifth interface configured to produce the second aligned plurality of serialized data streams from the first integrated circuit device, with the second aligned plurality of serialized data streams not being framed within the first integrated circuit device.

13. An integrated circuit device, comprising:
an input interface configured to receive an input plurality of serialized data streams from a source external to the integrated circuit device;
first phase aligning circuitry, communicatively coupled to the input interface, configured to align, but not frame, the input plurality of serialized data streams to produce a first aligned plurality of serialized data streams;
a first interface configured to produce the first aligned plurality of serialized data streams from the integrated circuit device, with the first aligned plurality of serialized data streams not being framed within the integrated circuit device;
second phase aligning circuitry, communicatively coupled to the input interface, configured to align, but not frame, the input plurality of serialized data streams to produce a second aligned plurality of serialized data streams;
a second interface configured to produce the second aligned plurality of serialized data streams from the integrated circuit device, with the second aligned plurality of serialized data streams not being framed within the integrated circuit device;
a third interface configured to receive a second plurality of serialized data streams from a source external to the integrated circuit device;
first framing circuitry, communicatively coupled to the third interface, configured to produce a first sequence of data frames from the second plurality of serialized data streams;
a fourth interface configured to receive a third plurality of serialized data streams from a source external to the integrated circuit device;
second framing circuitry, communicatively coupled to the fourth interface, configured to produce a second sequence of data frames from the third plurality of serialized data streams;
combining and framing circuitry configured to produce an output plurality of serialized data streams based on the first sequence of data frames and on the second sequence of data frames; and
an output configured to produce the output plurality of serialized data streams from the integrated circuit device.

14. A method, comprising:
receiving, by a device, a first plurality of serialized data streams from a source external to the first device;
communicating, from the device, one or more copies of the first plurality of serialized data streams, each of said one or more copies of the first plurality of serialized data streams having been phase aligned by the device, but not framed by the device;
framing each of one or more second plurality of serialized data streams received from a same or different source external to the first device to generate one or more sequences of data frames;
producing a result based on said one or more sequences of data frames;
generating an output plurality of serialized data streams including by framing the result; and
sending, from the device, the output plurality of serialized data streams.

15. A method of claim 14, wherein the device is an integrated circuit device in a cascade of a plurality of integrated circuit devices.

16. The method of claim 14, wherein said producing the result includes multiplexing said one or more sequences of data frames.

17. The method of claim 14, wherein said producing the result includes:
framing the first plurality of serialized data streams to generate an input sequence of data frames;
processing, by the device, according to instructions or data received in the input sequences of data frames, to produce an intermediate result; and
processing the intermediate result and information received in said one or more sequences of data frames resulting in the result.

18. The method of claim 17, wherein said processing according to said instructions or data received in the input sequences of data frames to produce the intermediate result includes performing an associative memory lookup operation in the device based on a lookup word generated from, or included in, the input sequences of data frames.

19. A method of claim 18, wherein said information received in said one or more sequences of data frames includes a subsequent stage lookup result performed according to instructions or data included in at least one of said one or more copies of said serialized data streams said communicated from the device.

20. The method of claim 19, wherein said one or more copies of the first plurality of serialized data streams consists of one copy of the first plurality of serialized data streams; and wherein said one or more second plurality of serialized data streams consists of one plurality of serialized data streams.
